(19) United States
(12) Patent Application Publication
(10) Pub. No.: US 2006/0027267 A1
(43) Pub. Date: Feb. 9, 2006

(54) Systems and methods for detecting and eliminating leaks in water delivery systems for use with appliances

(76) Inventor: Karl Fritze, Denmark Township, MN (US)

Correspondence Address: CUNO INCORPORATED, 400 RESEARCH PARKWAY, P. O. BOX 1018, MERIDEN, CT, 06450-1018, US

(21) Appl. No.: 11/189,547

(22) Filed: Jul. 26, 2005

Related U.S. Application Data
(60) Provisional application No. 60/591,017, filed on Jul. 26, 2004.

(51) Int. Cl. G05D 7/06; F25D 29/00

(52) U.S. Cl. 137/487.5; 62/189

(57) ABSTRACT

Apparatus and methods for detecting and eliminating water flow leakage conditions within appliances having integral water filtration systems. Leak free water delivery systems for use with an appliance can include an isolation valve and flow sensor for providing a response mechanism for possible water leakages within the integral water filtrations system. The appliance makes use of a flow sensor to sense water flow rates within a preselected flow range. When water flow rates outside the preselected flow range are sensed, the isolation valve is closed to prevent non-transient water flow through the water system. The isolation valve can be remotely located on an inlet line or can be as a part of the integral water filtration system. The integral water filtration system can include a manual or automatic reset mechanism such that a user can restore water flow after a low flow or high flow situation has been rectified.

### PRIORITY CLAIM

The present application claims priority to and is a continuation-in-part of U.S. Provisional Application No. 60/591,017 filed Jul. 26, 2004, and entitled, “LEAK TERMINATING WATER DELIVERY SYSTEMS FOR USE WITH APPLIANCES,” the disclosure of which is herein incorporated by reference to the extent not inconsistent with the present disclosure.

### BACKGROUND OF THE DISCLOSURE

The present disclosure relates to water delivery systems for supplying water during operation, in which the water delivery systems can also have a filter, such as those utilized in appliances. More particularly, the present disclosure relates to an isolation style valve capable of mechanically or electrically responding to a sensed water flow rate that can provide indications of system leakage from appliances having water delivery systems for supplying water during operation.

A wide variety of household appliances requires a water source in order to perform their intended operation in the intended environment. One common example is a refrigerator that may use water in a variety of ways such as, for example, to make and deliver ice in an automated ice maker and deliver the ice to an end user or to provide potable water through a water dispensing assembly. Generally, these household appliances include some form of inlet connection that connects to a water supply, such as a municipal water supply or a well. This inlet connection can comprise various quick-connect style connectors as well as more traditional threaded connectors. Irrespective of the connector style, the connectors should provide reliable, leak free connections, as any leaking at the connector location may go unnoticed since the connections tend to be made on the bottom and/or rear of the appliance, which may not be readily viewable by an end user. Unnoticed leaking at the connections can lead to severe and extensive damages, such as, for example, to a hardwood floor, walls or lower levels of a house in the case of a residential appliance. As many modern home designs include laundry rooms on upper floors for convenience to the homeowner, the consequences of unnoticed leaking connections is further magnified.

In many instances, it is desirable to have a water filtration system integral to an appliance. For example, these filtration systems can be used to remove dissolved minerals, organic matter or particulate matter that has the potential to interfere with the appliance's operation or service life. In addition, the use of a water filtration system can be used to improve the overall performance of the appliance, for example, by eliminating spotting in a dishwasher, providing cleaner clothes in a washing machine or producing better tasting beverages in a refrigerator, coffee pot or the like.

When water filtration systems are integrated into appliances, the possibility of system leakage increases due to the increased number of connections and components that go into installing and assembling the water filtration system. In addition, the environment in which the water filtration system is located can increase the potential for leakage, for example, leakage occurring from freezing ruptures when used with ice makers and refrigerators. Due to the increasing popularity of installing appliances having water filtration systems in homes, it is desirable to identify and significantly reduce, if not totally eliminate leaking within the water filtration system as early as possible so as to limit the amount of damage that can directly result from such leakage.

### SUMMARY OF THE DISCLOSURE

Presently preferred representative embodiments of leak free water delivery systems of the present disclosure can comprise an isolation valve and flow sensor for providing a response mechanism for sensing and acting upon possible water leakages within an integral water system of an appliance. Representative embodiments of the leak free water delivery systems as described herein make use of a flow sensor and control unit to sense and maintain water flow through the integral water system within desired, preselected operational flow ranges. When the sensor and control unit determine that a sustained, measured water flow rate is outside of the preselected flow range, the control unit can terminate water flow into the integral water system by directing the isolation valve to close, thus preventing water flow through the integral water system.

In some representative embodiments of the present disclosure, the isolation valve can be generally located on an inlet line to the integral water system and may be fabricated as either a stand-alone unit or as an integral component of the water system. The flow sensor and control unit can comprise a single, integral assembly while in alternative, representative embodiments, the flow sensor can be remotely located from the control unit. In some presently preferred representative embodiments, the integral water system can comprise a filtration unit wherein the isolation valve can be an integral component of the filtration unit. Furthermore, the integral water system can comprise a reset mechanism such that a user can restore water flow, either manually or automatically, to the integral water system after a lower limit flow rate or upper limit flow rate situation has been identified and corrected.

In general, the flow range is selected based on the expected range of inlet water pressures and the flow characteristics of the water system. A flow rate above the upper limit flow rate would be indicative of a leak downstream from the flow meter that results in a greater flow rate than would be expected for a normal flow rate through the water system. A flow rate below the lower limit flow rate would be indicative of a leak upstream from the flow meter resulting in drop in fluid pressure and a corresponding drop in flow rate through the water system. For a residential water system, such as, for example, a filtered water dispenser for a refrigerator, a reasonable flow rate range would be from about 0.1 to about 1.0 gallons per minute.

The actuated valve generally can be effectively placed in a range of locations relative to the other components of an appliance. Similarly, the actuator valve may be upstream or downstream from the flow meter. However, the actuator valve is not effective to detect and thus be operative to stop leaks if located downstream from the actuated valve. Therefore, placement of the actuator valve should take into account possible vulnerable leakage points within the appliance or connections to and within the appliance. Therefore, one potentially effective location of the actuator valve is at or adjacent the inflow connection of an appliance to the fluid/water supply.

In some presently preferred representative embodiments of leak free water delivery systems according to the present disclosure, the leak free water delivery systems can comprise an integral water system having both an isolation valve and flow sensor. The integral water system can be positioned and/or mounted on an interior or exterior portion of an appliance so as to provide filtered water to points-of-use on the appliance such as, for example, a wash tub, a door mounted dispenser and/or an icemaking apparatus, as is known in the art. In some presently contemplated representative embodiments, the integral water system can comprise a filtration system having a filter manifold and a replaceable filter element. For these embodiments, a flow sensor can be an integral component of the filter manifold. Similarly, the isolation valve can be an integral component of the filter manifold, which can provide for quick and easy installation of the integral water system. In some alternative embodiments, the isolation valve can be remotely located from the integral water system such as, for example, individually mounted to the appliance or as part of an inlet water supply.

Through the measurement of the water flow rate into the integral water system by the flow sensor, closure of the isolation valve can be automatically triggered when non-transient water flow into the integral water system falls outside a preselected range of flow rates having an upper cut off and a lower cut off. Evaluation of the flow rate cut offs and control of the isolation valve can be accomplished by processing a signal generated by the flow sensor with a suitable control unit such as, for example, a microprocessor based controller, a PLC (Programmable Logic Controller) and other suitable logic components known to one of skill in the art. In some presently contemplated representative embodiments, the integral water system can further comprise a reset mechanism, either manually or automatically actuated, such that the water flow rate can be restored to the integral water system after the isolation valve has been closed due to a measured flow rate outside the preselected flow rate range.

In another aspect of the present disclosure, representative water-using appliances can comprise a water circuit having an isolation valve, a flow sensor and a water filtration system. The water filtration system can comprise a distribution manifold and replaceable filter such as, for example, a rotatably or slidably, or a single motion push-pull attachable cartridge filter. In a representative embodiment, the distribution manifold can comprise the isolation valve and/or the flow sensor fabricated as part of an inlet flow channel within the distribution manifold. The isolation valve can be appropriately designed and installed such that the isolation valve remains open when a measured flow rate into the distribution manifold falls within certain specified upper and lower flow rate limits while sensing of non-transient flow outside of the specified flow range can result in closure of the isolation valve until the water filtration system is automatically or manually reset. The water filtration system, according to the present disclosure, can comprise a reset mechanism, either manually or automatically initiated, whereby the water filtration system is reset for operation following restoration of the measured water flow rate to a satisfactory operational flow rate within the preselected flow rate range defined by a minimum acceptable or lower limit flow rate and a maximum acceptable or upper limit flow rate.

In a further aspect, according to the present disclosure, representative methods of detecting and eliminating water leakage in residential appliances having integral water systems. By insuring that an operational water flow rate stays within certain preselected upper and lower flow rate limits, low flow rates and high flow rates scenarios that are indicative of leakage situations can be quickly identified by a flow sensor and eliminated through closure of an isolation valve in the water filtration system. In addition to detecting and preventing water leakage, representative methods of the present disclosure can further comprise acts for resetting the water filtration system, either automatically or manually, so as to reset the water filtration system and reinitiate operation of the appliance and correspondingly, the water filtration system, after a leakage situation has been remedied.

In some additional representative embodiments, the water system comprises a mechanical isolation valve that automatically closes if the non-transient flow rate is outside of a particular preselected flow rate range. To reset the valve in an appliance without needing to disconnect or partially disconnect the valve from the water system, the system can be designed with a bypass valve. The bypass valve is connected to a bypass flow circuit such that opening of the bypass valve can equalize the pressure on the two sides of the mechanical isolation valve to reset the isolation valve and to allow resumed flow through the isolation valve. Thus, the use of the bypass valve provides a convenient and practical way to reset the mechanical isolation valve mounted within an appliance. The bypass valve can be a manual valve or an automatic valve connected to a control unit.

### BRIEF DESCRIPTION OF THE DRAWINGS

FIG. 1 is a schematic view of an appliance having an isolation valve and a flow sensor in a water circuit.

FIG. 2 is a schematic view of an alternative embodiment of an appliance having an isolation valve in a water circuit.

FIG. 3 is a schematic view of an appliance having an isolation valve, a flow sensor and a filtration system in a water circuit.

FIG. 4 is a schematic view of an alternative embodiment of an appliance having an isolation valve and a filtration system in a water circuit.

FIG. 5 is a schematic view of an alternative embodiment of an appliance having an isolation valve and a filtration system in a water circuit.

FIG. 6 is a schematic view of an alternative embodiment of an appliance having an isolation valve, filtration system and diverter valve in a water circuit.

### DETAILED DESCRIPTION OF REPRESENTATIVE EMBODIMENTS

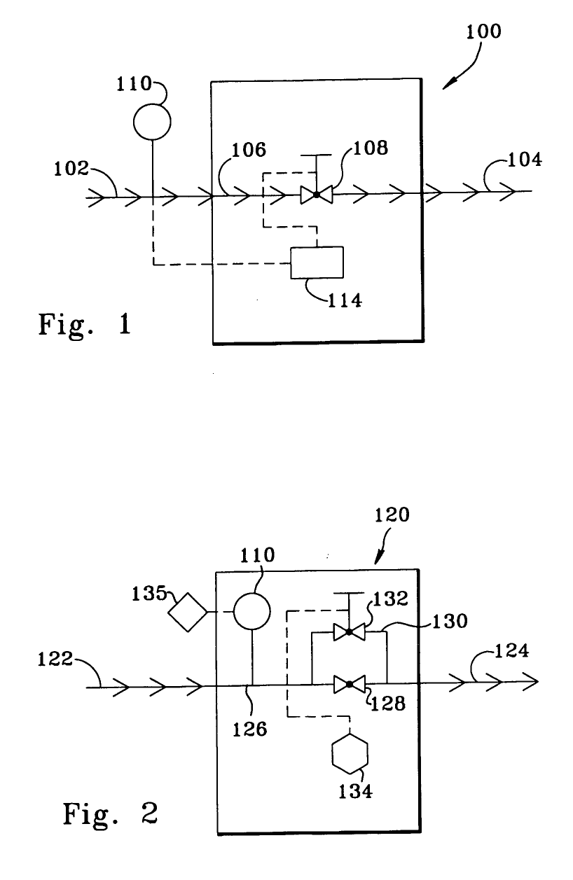

A schematic view of a representative residential appliance 100 of the present disclosure is depicted in FIG. 1. Residential appliance 100 can be one of a variety of appliances that utilize water to perform a function within the appliance. Suitable examples can include, but are not limited to, residential appliances, such as refrigerators with automated ice makers and/or drinking water dispensers, coffee makers, dishwashers, washing machines, humidifiers, water softeners, beverage dispensers and the like.

As illustrated in FIG. 1, appliance 100 can comprise an inlet water line 102, an outlet water line 104, an appliance water circuit 106 and an actuatable isolation valve 108. Actuatable isolation valve 108 can comprise suitable valve designs such as, for example, electrically actuated, hydraulically actuated or pneumatically actuated valves capable of opening and closing as directed by an actuator. In some presently preferred embodiments, actuatable isolation valve 108 can comprise an electrically actuated solenoid valve, although other equivalent valve styles capable of performing the desired function in the intended environment known to one skilled in the art can be used as well. While actuatable isolation valve 108 is illustrated as being part of the appliance 100, it is to be understood that actuatable isolation valve 108 can be remotely located apart from the appliance 100 such as, for example, within the inlet water line 102, as long as the actuatable isolation valve controls inlet flow through the appliance water circuit.

Referring to FIG. 1, a flow sensor 110 can be mounted within the inlet line 102. Flow sensor 110 can take the form of a suitable flow measurement device such as, for example, a paddlewheel flow sensor such as those available from George Fischer Signet, Inc., of El Monte, Calif., Omega Engineering, Inc., of Stamford, Conn. and Newport Electronics, Inc., of Santa Ana, Calif., as well as other suitable flow sensors capable of performing the desired function in the intended environment including a turbine flow sensor, an ultrasonic flow sensor, or similar flow rate measuring devices capable of converting flow rate measurements to electronic data such as, for example, an analog or digital signal. Outlet line 104 can take the form of a drain line in a washing machine for emptying used wash water following completion of a wash cycle. In other appliances, outlet line 104 can take the form of a water tap or other functional unit such as, for example, an automated icemaker.

Flow sensor 110 can be operatively, electronically connected to a control unit 114 that is capable of receiving and processing electronic data sent from the sensor. Control unit 114 can comprise a suitable electronic control device such as, for example, a microprocessor based controller or a Programmable Logic Controller (PLC) capable of receiving, interpreting and acting upon the electronic data received from the flow sensor 110. In some representative embodiments, control unit 114 can be a separate component apart from the flow sensor 110. The control unit can be physically located on, within or remotely from the appliance 100. Similarly, components of the control unit may or may not be packaged together in a single structure, such that certain components can be in operative, electrical connection with the other components of the control but are placed at desirable locations from the perspective of the user. Control unit 114 can be electrically connected to the actuatable isolation valve 108 such that the actuatable isolation valve 108 can be opened or closed based on a signal from control unit 114 after the control unit 114 has received and processed the electronic data from the flow sensor 110.

In operation, flow sensor 110 provides water flow rate information in the form of electronic data to the control unit 114. The control unit 114 can be programmed or otherwise designed to compare the water flow rate representative information from flow sensor 110 to a preselected flow rate range within the control unit 144 in which the preselected flow rate range is set between a minimum allowable or lower limit flow rate and a maximum allowable or upper limit flow rate. As long as the flow sensor measures an operational flow rate within the preselected flow rate range, the isolation valve 108 is maintained in an open or operational disposition. Of course, a zero or no flow condition is indicative of the water circuit being shut off and generally would not trigger an indication of flow rate below the lower limit flow rate. In some presently contemplated representative embodiments, control unit 114 can receive an input from a point of use such as, for example, a water dispenser or automatic icemaker, fluidly operatively connected to outlet water line 104 so as to provide an indication to control unit 114 that a zero or no flow rate condition is expected as there is presently no demand for water. Similarly, the same input from a point of use can provide an indication to control unit 114 that a flow rate is expected and if in fact, no flow rate is detected by the flow sensor 110, that a problem and/or leak has occurred upstream of the flow sensor 110.

In the event that the operation water flow rate falls either below the lower limit flow rate or exceeds the upper limit flow rate, the control unit 114 can direct the actuatable isolation valve 108 to a closed disposition so as to prevent further water flow through the appliance water circuit 106. In some representative embodiments, control unit 114 can have a delay function such that any initial flow rate fluctuations that occur upon initial start-up of the water flow can be allowed to dampen or equilibrate so as to not close actuatable isolation valve 108 if the water flow quickly reaches a flow rate within the preselected flow rate range. In addition, control unit 114 can incorporate additional electronic filtering methods for ignoring the effect of transient start-up conditions such as, for example, flow rate trending and/or flow rate averaging. Alternatively, flow sensor 110 can be specifically selected to have a slow response time so as to dampen transient start-up conditions. Thus, the system generally responds to sustained flow, which can be considered the flow rate within the system. Also, transient responses during operation may not indicate a leak condition, but may be the result of transient fluctuations in water supply pressures. Similar flow rate trending and/or flow rate averaging can be used to account for these fluctuations. A suitable averaging time, such as one second, 10 seconds or other reasonable period can be selected. While described for use with both a lower limit flow rate and an upper limit flow rate, flow sensor 110 and/or control unit 114 can be designed to operate with a single limit or alarm point, such as, for example, either a lower limit flow rate or an upper limit flow rate.

Some presently preferred representative embodiments of control unit 114 can further comprise an alarm signal and/or alarm output, either audible or visual, that indicates closure of the actuatable isolation valve 108 such that a user can further investigate possible conditions that have led to water flow rates outside the preselected flow rate range. In the event that control unit 114 comprises an alarm output, an alarm indicator can be remotely located from the control unit such as, for example, on a refrigerator door, a dishwasher door or a washing machine control panel, such that electrical interconnection of the alarm output and alarm indicator can provide an alarm indication to an end user.

Another presently contemplated representative embodiment of a residential appliance 120 of the present disclosure is illustrated in FIG. 2. Residential appliance 120 can comprise an inlet water line 122, an outlet water line 124 and an appliance water circuit 126. Appliance water circuit 126 can further comprise a mechanical isolation valve 128 and a bypass circuit 130 having a bypass valve 132. Mechanical isolation valve 128 can comprise valves similar to those manufactured by Brightvalve LLC, of Redondo Beach, Calif., and as described in U.S. Pat. Nos. 6,173,734, 6,374,852 and 6,634,375, all of which are herein incorporated by reference to the extent not inconsistent with the present disclosure. Mechanical isolation valve 128 generally has a flow adjustment that can be configured to allow water flow within a preselected range of flow rates between a lower limit flow rate and an upper limit flow rate. In some presently contemplated embodiments, bypass valve 132 can comprise a manual valve such as a ball valve or an actuatable valve such as an electrically actuated, hydraulically actuated or pneumatically actuated valve. In the embodiments in which bypass valve 132 comprises an actuatable valve, bypass valve 132 can be opened and closed, either manually by a pushbutton 134 or automatically as directed by the control unit 114. While the mechanical isolation valve 128 and bypass circuit 130 are illustrated as being part of the appliance 120, it is to be understood that they can be remotely located within the inlet water line 102 without departing from the spirit and scope of the claims of the present disclosure.

In operation, mechanical isolation valve 128, through various mechanisms including for example, springs, poppet valve areas and a choke ring, mechanically allows water flow within the preselected flow range. If the non-transient water flow rate falls below the preselected minimum or lower limit flow rate or exceeds the desired maximum or upper limit flow rate, the mechanical isolation valve 128 closes to prevent water flow through the appliance water circuit 126. Residential appliance 120 can comprise a flow sensor and display for example flow sensor 110 and a display 135, to provide a visual indication when mechanical isolation valve 128 has closed and water is no longer flowing through residential appliance 120. For example, display 135 can be externally located on residential appliance 120 so as to provide a user with visual notice of a no flow condition. In some representative embodiments, display 135 can further comprise an audible alarm to audibly indicate a no flow condition. After an end user has corrected the flow problems related to the closure of mechanical isolation valve 128, the end user can open bypass valve 132, for example by actuating pushbutton 134, such that flow conditions are restored and mechanical isolation valve 128 can be reset to an operative condition.

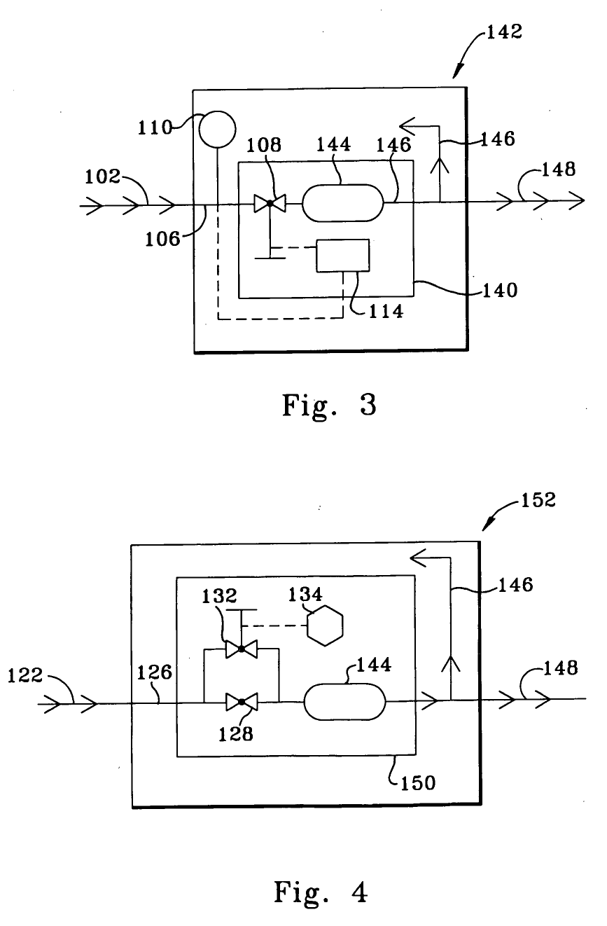

In another alternative representative embodiment of a residential appliance according to the present disclosure, the appliance water circuit 106 can comprise a filtration assembly 140 to form a residential appliance with filter 142, as shown in FIG. 3. Filtration assembly 140 can take the form of any suitable filtration assembly, for example, configurations having flow manifolds and replaceable filter cartridges. In some representative embodiments, filtration assembly 140 can comprise replaceable filter cartridges that are rotatably, slidably or single-motion push-pull replaceable with a filtration manifold. Filtration assembly 142 can comprise a filter media 144 such as, for example, activated carbon, ion exchange media, membrane media, hollow fiber media, polymeric barrier media or other suitable filtering medias in various forms, for example in the form of replaceable, sealed cartridge filters. Representative embodiments of filtration assembly 140 and corresponding replaceable cartridge filters include, but are not limited to, for example, those shown and described in U.S. Pat. Nos. 6,027,644, 6,193,884, 6,632,355 and 6,649,056, as well as U.S. Patent Publ. Nos. 2003-0019819 A1, 2003-0024860 A1, 2004-0007516 A1, 2004-0251192 A1, and U.S. Provisional Applications Nos. 60/505,152, 60/512,574, 60/515,049 and 60/520,116, all of which are herein incorporated by reference to the extent not inconsistent with the present disclosure. Replaceable cartridge filters can comprise leak resistant filter cartridges such as, for example, those described in the above referenced patents and patent applications.

Filtration assembly 140 can comprise actuatable isolation valve 108 within a filter water circuit 146 as shown in FIG. 3 or actuatable isolation valve 108 can be separately mounted upstream of the filtration assembly 140. In addition, filtration assembly 140 can also have a flow sensor 110, as shown in FIG. 3, or alternatively, flow sensor 110 can be mounted upstream of the filtration assembly 140. Both actuatable isolation valve 108 and flow sensor 110 can be in communication with control unit 114, although control functions can be separated into more than one unit. Based on the flow data transmitted from the flow sensor 110, actuatable isolation valve 108 can be closed by the control unit 114 if the water flow rate falls below a lower limit flow rate or water flow rate exceeds an upper limit flow rate as established and preselected within control unit 114, or alternatively when control unit 114 is expecting water, as indicated by an external input, and flow sensor 110 is not sensing any flow rate or conversely when control unit 114 Is not expecting water, as indicated by an external input, and flow sensor is sensing a flow rate. When water is allowed to flow through filter media 144, filtered water can be directed, for example, in the case of a refrigerator to an icemaking flow circuit 146 and/or a drinking water dispensing circuit 148.

In another presently contemplated representative embodiment, an appliance water circuit can comprise a filtration assembly 150 to form a residential appliance with filter 152 as shown in FIG. 4. Filtration assembly 150 can take the form of any suitable filtration assembly as previously described above. Filtration assembly 150 can include mechanical isolation valve 128 and bypass circuit 130 having bypass valve 132. Mechanical isolation valve 128 and bypass circuit 130 can be integral to the filtration assembly 150 or mounted upstream of the filtration assembly 150. As described previously, mechanical isolation valve 128 mechanically allows water flow within the preselected flow range. If the water flow rate falls below the preselected lower limit flow rate or exceeds the preselected upper limit flow rate, the mechanical isolation valve 128 closes to prevent water flow through the appliance water circuit 126. As described above, a flow sensor and display, for example flow sensor 110, can be used to provide an indication when mechanical isolation valve 128 has closed and water is no longer flowing through appliance water circuit 126. Once again, the residential appliance with filter 152 can include a mechanism, for example, pushbutton 134 to reset the mechanical isolation valve 128 and restore operation of the filtration assembly 150.

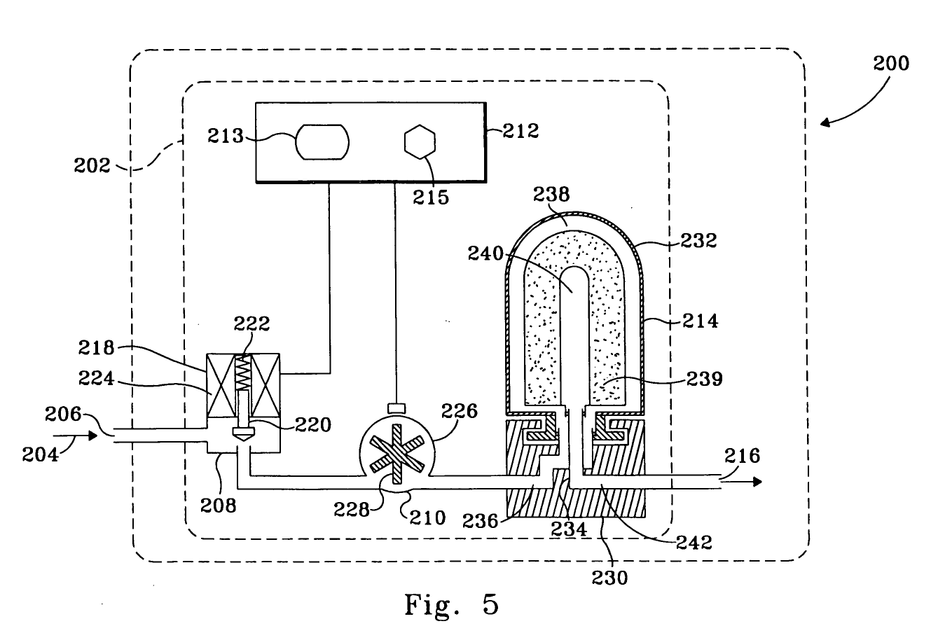

Another representative embodiment of an appliance 200 having an internal water system 202 is illustrated in FIG. 5. As depicted, an inlet water supply 204 is supplied to a system inlet 206 on the appliance 200. System inlet 206 can comprise a threaded style connector, a quick-connect tubing connector or other suitable connectors known to one of skill in the art. Internal water system 202 can comprise an actuatable isolation valve 208, a flow sensor 210, a control unit 212, a filter system 214 and a dispensing flow circuit 216. Actuatable isolation valve 208 can comprise a solenoid valve 218 comprising a valve plunger 220, a spring return 222 and a solenoid coil 224. Alternatively, actuatable isolation valve 208 can comprise other suitable actuatable valve assemblies known to one of skill in the art including electrically, pneumatically and hydraulically actuated valve assemblies. Flow sensor 210 can comprise a paddlewheel sensor 226 having an inline paddlewheel 228 for continually measure the flow rate of water past flow sensor 210. Both actuatable isolation valve 208 and flow sensor 210 are operatively connected to the control unit 212. Control unit 212 can comprise a suitable control unit known to one of skill in the art such as, for example, microprocessor or PLC based controllers capable of interpreting analog or digital data from flow sensor 210 and capable of providing an output to the actuatable isolation valve 208. Filter system 214 can comprise a filter manifold 230 and a replaceable filter element 232. Replaceable filter element 232 can be detachably connected to filter manifold 230 in either a rotatable, slidable or single motion push-pull manner. Filter system 214 can comprise a filter flow circuit 234 defined by a manifold inlet channel 236, a nonfiltered cartridge portion 238, a filter media 239, a filtered cartridge portion 240 and a manifold outlet channel 242.

Internal water system 202 can be used with appliance 200 by first programming control unit 212 with a one or both of a lower limit flow rate and/or an upper limit flow rate. In some representative embodiments, control unit 212 can display operational conditions and/or alarm conditions on a display unit 213 or can audibly identify alarm conditions with an audible alarm 215 as illustrated in FIG. 5. Display unit 213 and/or audible alarm 215 can comprise integral components of the control unit 212 or alternatively, can comprise assemblies operably interconnected to the control unit 212 but located remotely such as, for example, on a door or front portion of appliance 200. The programming of control unit 212 can be accomplished prior to installation of internal water system 202 within appliance 200 or can be programmed at a time of installation of appliance 200 at the location of use, such as, for example, a residence.

When filtered water is requested, either manually from a user actuating a dispenser tap or automatically such as, for example, by an automated icemaker, a valve downstream from filter system 214 can open wherein inlet water supply 204 flows into system inlet 206. Water can continue to flow through actuatable isolation valve 208, past flow sensor 210 and into manifold inlet channel 236. Within filter system 214, water enters the nonfiltered cartridge portion 238, passes through the filter media 239, into the filtered cartridge portion 240 and out the manifold outlet channel 242. Filtered water flows out the internal water system 202 through the dispensing flow circuit 216 and is directed to the desired point-of-use.

As water flows through the internal water system 202, an instantaneous flow rate through the system is continually measured by flow sensor 210. Flow sensor 210 communicates the measured instantaneous flow rate to control unit 212 where the instantaneous flow rate is continually compared against the programmed lower limit flow rate and/or an upper limit flow rate. If the instantaneous flow rate falls below the preselected and programmed lower limit flow rate, or does not register at all or if the instantaneous flow rate increases above the preselected and programmed upper limit flow rate or if a flow rate is measured when there should not be flow, each of said conditions being indicative of a potential leak situation within internal water system 202, the control unit 212 energizes solenoid coil 224 such that valve plunger 220 closes actuatable isolation valve 208 to prevent further leakage. In such an event, control unit 212 can cause alarm information to be displayed on display unit 213 or alternatively, can cause an audible alarm to be generated by audible alarm 215. In addition to monitoring the instantaneous flow rate, control unit 212 can further comprise a flow totalization feature allowing the flow data measured by flow sensor 210 to be accumulated such that control unit 212 can monitor the remaining filter capacity of replaceable filter element 232. When the accumulated total flow through replaceable filter element 232 exceeds a specified design threshold, control unit 212 can cause one or both of display unit 213 and/or audible alarm 215 to provide notification that the replaceable filter element 232 requires replacement.

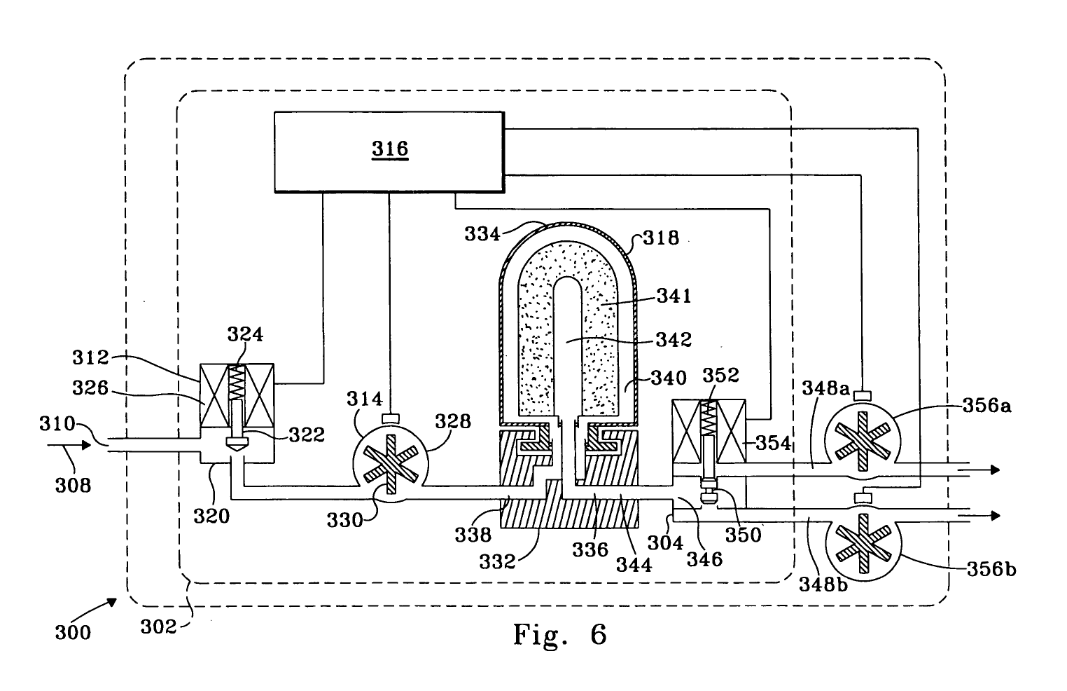

As illustrated in FIG. 6, another representative embodiment of an appliance 300 can comprise an internal water system 302 that resembles internal water system 202 with the further inclusion of a diverter valve assembly 304 for selectively diverting filtered water flow to a desired point of use with a dual dispensing flow circuit 306. Similarly to internal water system 202, internal water system 302 can comprise an inlet water supply 308 that is operatively, fluidly connected to a system inlet 310 on the appliance 300. System inlet 310 can comprise a threaded style connector, a quick-connect tubing connector or other suitable connectors known to one of skill in the art. Internal water system 302 can further comprise an actuatable isolation valve 312, a flow sensor 314, a control unit 316 and a filter system 318. Actuatable isolation valve 312 can comprise a solenoid valve 320 comprising a valve plunger 322, a spring return 324 and a solenoid coil 326. Alternatively, actuatable isolation valve 312 can comprise other suitable actuatable valve assemblies known to one of skill in the art including electrically, pneumatically and hydraulically actuated valve assemblies.

Flow sensor 314 can comprise a paddlewheel sensor 328 having an inline paddlewheel 330 for continually measuring the flow rate of water past flow sensor 314. Both actuatable isolation valve 312 and flow sensor 314 are operatively connected to the control unit 316. Control unit 316 can comprise a suitable control unit known to one of skill in the art such as, for example, microprocessor or PLC based controllers capable of interpreting analog or digital date from flow sensor 314 and capable of providing an output to the actuatable isolation valve 312.

Filter system 318 can comprise a filter manifold 332 and a replaceable filter element 334. Replaceable filter element 334 can be detachably connected to filter manifold 332 in either a rotatable, slidable or single motion push-pull manner. Filter system 318 can comprise a filter flow circuit 336 defined by a manifold inlet channel 338, a nonfiltered cartridge portion 340, a filter media 341, a filtered cartridge portion 342 and a manifold outlet channel 344. Diverter valve assembly 304 can comprise a suitable valve design known to those of skill in the art such as, for example, electrically, pneumatically or hydraulically actuated diverter valves. As illustrated in FIG. 6, diverter valve 304 can comprise a diverter valve inlet 346 fluidly coupled to a pair of diverter valve outlets 348a, 348b. Diverter valve outlets 348a, 348b can be operatively, fluidly connected to alternative points-of-use such as, for example, diverter valve outlet 348a connected to a water dispensing tap and diverter valve outlet 348b connected to an automated icemaker in the case of appliance 300 comprising a refrigerator. Diverter valve 304 can comprise a solenoid-style valve having a two-position valve plunger 350, a spring return 352 and a solenoid coil 354.

Internal water system 302 can function similarly as previously described with respect to internal water system 202. Generally, instantaneous flow rates are similarly measured by flow sensor 314 and are communicated to control unit 316 for comparison to the preselected and programmed lower limit flow rate and/or upper limit flow rate. If the measured instantaneous flow rate falls below the lower limit flow range and/or exceeds the upper limit flow rate, control unit 316 directs actuatable isolation valve 312 to close so as to eliminate potential leaks within internal water system 302.

The significant difference between internal water system 302 and internal water system 202 is directed to the use and operation of diverter valve assembly 304. For instance, the dual dispensing flow circuit 306 allows internal water system 302 to provide filtered water to multiple points-of-use such as, for example, a water dispensing tap operatively, fluidly coupled to diverter valve outlet 348a and an automated icemaker fluidly coupled to diverter valve outlet 348b in the case of appliance 300 comprising a refrigerator. Solenoid coil 354 can be electrically actuated based on a filtered water request such as, for example, from the water dispensing tap or automated icemaker, such that two-position valve plunger 350 selectively directs filtered water through either of the diverter valve outlets 348a, 348b.

In some representative embodiments, internal water system 302 can operate with additional monitoring and/or sensing instruments so as to provide further opportunities for sensing and preventing leak conditions. For instance, internal water system 302 can comprise a pair of dispensing flow sensors 356a, 356b located downstream of diverter valve outlets 348a, 348b. The dispensing flow sensors 356a, 356b can comprise a similar flow sensor design as flow sensor 314 and can be operatively, electrically interconnected to control unit 316 to relay instantaneous flow rates downstream of the diverter valve assembly 304. These downstream instantaneous flow rates can be compared to the instantaneous flow rates measured by flow sensor 314. Significant differences measured by flow sensor 314 in comparison to the dispensing flow sensors 356a, 356b, either individually or in combination depending upon downstream flow requirements, can be further indicative of leak conditions, such as, for example, within the filter system 318. In either case, control unit 316 can close actuatable isolation valve 312 if the measured instantaneous flow rates are not essentially equal.

Although various embodiments of the disclosure have been disclosed here for purposes of illustration, it should be understood that a variety of changes, modifications and substitutions may be incorporated without departing from either the spirit or scope of the claims of the present disclosure.

What is claimed:

1. An appliance comprising an integral water system and a leak detecting and eliminating device, the device comprising:
a flow sensor operatively positioned to measure an inlet flow rate to the integral water system and generate a signal related to a measured inlet flow rate;
an isolation valve operatively positioned to selectively allow or stop inlet water flow to the integral water system; and
a control unit operatively interconnected to the flow sensor and the isolation valve, the control unit comprising a control processor that compares the measured inlet flow rate from the signal generated by the flow sensor to a preselected flow range defined by a lower limit flow rate and an upper limit flow rate, and that directs the isolation valve to a closed configuration when the measured inlet flow rate is outside the preselected flow rate range.

2. The appliance of claim 1, wherein the control unit and the flow sensor comprise a single, integral flow component.

3. The appliance of claim 1, wherein the control unit is selected from the group comprising: a microprocessor, a PLC and a relay-logic circuit.

4. The appliance of claim 1, wherein the control unit further comprises:
a reset mechanism for resetting the integral water system, the reset mechanism operatively directing the control element to position the isolation valve in an open configuration so as to restore inlet flow to the integral water system.

5. The appliance of claim 4, wherein the reset mechanism comprises a manually initiated switch, the manually initiated switch being operatively connected to the control unit.

6. The appliance of claim 1, wherein the integral water system comprises a distribution manifold and a removable water filter, the distribution manifold and removable water filter defining a filtration circuit between a manifold inlet and a manifold outlet.

7. The appliance of claim 6, wherein the flow sensor is operatively, fluidly positioned within the filtration circuit.

8. The appliance of claim 6, wherein the control element is operatively, mounted to the distribution manifold.

9. The appliance of claim 1, wherein the flow sensor comprises a paddle wheel flow sensor and the isolation valve comprises a solenoid valve.

10. The appliance of claim 1, wherein the control unit comprises a sound emitter that emits an audible signal when the flow comparison between the inlet flow rate and the preselected flow range indicates the presence of a leak.

11. The appliance of claim 1, wherein the control unit comprises a display that provides a visual signal when the flow comparison between the inlet flow rate and the preselected flow range indicates the presence of a leak.

12. The appliance of claim 1, further comprising:
a diverter valve assembly for selectively directing water flow to one of a plurality of points-of-use.

13. The appliance of claim 1, further comprising:
a second flow sensor positioned downstream of the flow sensor, the second flow sensor operatively positioned to measure a downstream flow rate from the integral water system and generate a signal related to a measured downstream flow rate, the second flow sensor operatively interconnected to the control unit wherein the control unit compares the measured inlet flow rate from the signal generated by the flow sensor to the measured downstream flow rate from the signal generated by the second flow sensor wherein the control unit directs the isolation valve to a closed configuration when a system leak is identified by having the measured inlet flow rate and measured downstream flow rate being generally unequal for a non-transient period of time.

14. The appliance of claim 1, wherein the appliance is selected from the group consisting of a refrigerator, a coffee maker, a dishwasher, a washing machine, a humidifier, a water softener and a beverage dispenser.

15. The appliance of claim 1, wherein the control unit receives an external input indicative of whether a water flow is requested through the integral water system and wherein the control unit compares the external input to the measured inlet flow rate to selectively allow or stop inlet water flow to the integral water system.

16. A method for eliminating water system leakages within an appliance comprising:
measuring an inlet flow rate to a water system with a flow sensor; and
comparing with a flow processor, the inlet flow rate to a preselected operational flow range defined by an operational flow rate lower limit and an operational flow rate upper limit wherein an isolation valve is closed when the inlet flow rate falls outside the preselected operational flow range.

17. The method of claim 16, further comprising:
resetting the water filtration system after a system leakage event has been resolved, wherein the isolation valve is opened such that water is allowed water to enter the water filtration system.

18. The method of claim 16, wherein the flow sensor comprises a paddlewheel flow sensor and the isolation valve comprises a solenoid valve.

19. The method of claim 16, wherein the water system comprises a replaceable filter.

20. A refrigerator comprising:
a refrigeration compartment;
a water system having a replaceable filter element, wherein at least a portion of a flow path of the water system passes through the refrigeration compartment;
a flow sensor operatively positioned to measure inlet flow to the filter element and generate a signal indicative of the inlet flow;
an isolation valve operatively positioned to measure an inlet flow rate to the filter element; and
a control unit operatively connected to the flow sensor and isolation valve, the control unit comprising a control processor that compares the measured inlet flow from the signal from the flow sensor to a preselected flow range defined by an allowable flow rate lower limit and an allowable flow rate upper limit, and that directs the isolation valve to a closed configuration when a system leak is identified by having the measured inlet flow fall outside the preselected flow range.
